(19) United States
(12) Patent Application Publication
(10) Pub. No.: US 2010/0231118 A1
(43) Pub. Date: Sep. 16, 2010

(54) CATHODE BODY AND FLUORESCENT TUBE USING THE SAME

(75) Inventors: Tadahiro Ohmi, Miyagi (JP); Tetsuya Goto, Miyagi (JP)

Correspondence Address: FOLEY AND LARDNER LLP;SUITE 500, 3000 K STREET NW, WASHINGTON, DC, 20007, US

(73) Assignees: NATIONAL UNIVERSITY CORPORATION TOHOKU UNIVERSITY; FOUNDATION FOR ADVANCEMENT OF INTERNATIONAL SCIENC

(21) Appl. No.: 12/678,038

(22) PCT Filed: Sep. 12, 2008
(86) PCT No.: PCT/JP2008/066530

§ 371 Date: Mar. 12, 2010

(30) Foreign Application Priority Data
Sep. 14, 2007 (JP) 2007-239219

(51) Int. Cl. H01J 63/04; H01J 1/304; H01J 9/02

(52) U.S. Cl. 313/491; 313/346 R; 445/35

(57) ABSTRACT

An object of the present invention is to provide a cathode body having a high intensity, a high efficiency, and a long life. The cathode body of the present invention is manufactured by forming, on a cylindrical cup formed of a metal alloy containing lanthanum oxide and having a high thermal conductivity, a LaB₆ film using a magnetron sputtering apparatus capable of sputtering at a low electron temperature.

### TECHNICAL FIELD

This invention relates to a cathode body, a fluorescent tube comprising the cathode body, and a method of manufacturing the cathode body.

### BACKGROUND ART

In general, a cold cathode fluorescent tube comprising a cathode body of the type is used in a light source of a backlight of a liquid crystal display device in a monitor, a liquid crystal television, or the like. The cold cathode fluorescent tube comprises a fluorescent tube member which is formed of a glass tube and which has an inner wall coated with a phosphor, and a pair of cold electrode members for emitting electrons. In the fluorescent tube member, a mixed gas, such as Hg—Ar, is confined.

Patent Document 1 proposes a cold cathode fluorescent tube comprising a cold cathode body having a cylindrical cup shape. Specifically, the cold cathode body of the cylindrical cup shape for emitting electrons comprises a cylindrical cup formed of nickel and an emitter layer having a boride of a rare earth element as a main constituent and formed on inner and outer wall surfaces of the cylindrical cup. In Patent Document 1, YB₆, GdB₆, LaB₆, and CeB₆ are exemplified as a boride of a rare earth element. The boride of a rare earth element is prepared into a fine powder slurry, applied to the inner and the outer wall surfaces of the cylindrical cup by flow coating, dried, and sintered to form the emitter layer.

On the other hand, Patent Document 2 discloses that a cold cathode body having a cylindrical cup shape is formed by mixing a material selected from La₂O₃, ThO₂, and Y₂O₃ with another material having a high thermal conductivity, such as tungsten. The cold cathode body of the cylindrical cup shape disclosed in Patent Document 2 is formed by, for example, injection-molding, namely, MIM (Metal Injection Molding) of a tungsten alloy powder containing La₂O₃.

Further, Patent Document 3 discloses a discharge cathode device for use in a plasma display panel. The discharge cathode device comprises, on a glass substrate, an aluminum layer formed as a base electrode and a LaB₆ layer formed on the aluminum layer. The aluminum layer is formed on the glass substrate kept at a preselected temperature by sputtering, vacuum vapor deposition, or ion plating while the LaB₆ layer is formed on the aluminum layer by sputtering or the like.

Patent Document 1: JP-A-10-144255

Patent Document 2: WO2004/075242

Patent Document 3: JP-A-5-250994

### DISCLOSURE OF THE INVENTION

### Problem to be Solved by the Invention

In Patent Document 1, the emitter layer is formed by applying the slurry having the rare earth element as a main constituent onto the cylindrical cup formed of Ni (nickel), drying the slurry, and sintering the slurry.

Patent Document 1 discloses that the emitter layer is reduced in thickness on the side of an opening end of the cylindrical cup and increased in thickness on the side of an external extraction electrode. Generally, the cylindrical cup has an inner diameter of approximately 0.6 to 1.0 mm and a length of approximately 2 to 3 mm. Therefore, when the emitter layer is formed by the technique of applying, drying, and sintering the slurry, it is difficult to apply the slurry to a desirable thickness. Further, the emitter layer obtained by applying, drying, and sintering the slurry is insufficient in adhesion with Ni. In addition, it is difficult to completely remove an organic material, moisture, and oxygen contained in a binder. As a result, in Patent Document 1, it is difficult to obtain a high-intensity and long-life cold cathode body.

In Patent Document 2, pellets are obtained by mixing the tungsten alloy powder containing La₂O₃ with a resin, such as styrene, and injection-molded in a mold to form a cold cathode body having a cylindrical cup shape. By using a material, such as tungsten, having a high thermal conductivity, it is possible to improve thermal conduction in the cold cathode body and to achieve a long life of the cold cathode body. However, the cold cathode body is insufficient in electron emission characteristic. Therefore, in Patent Document 2, it is difficult to obtain a high-intensity and high-efficiency cold cathode body.

Patent Document 3 discloses that a discharge cathode pattern comprising the LaB₆ layer and the aluminum layer is formed on the glass substrate by sputtering. However, the above-mentioned technique assumes that the aluminum layer and the LaB₆ layer are formed on the glass substrate of a flat shape by sputtering. No disclosure is made about a technique of forming the layers by sputtering on the cold cathode body having the cylindrical cup shape which is not flat. Further, Patent Document 3 does not disclose that, on a material except the glass substrate, the LaB₆ layer is formed with high adhesion without interposing the aluminum layer. Furthermore, Patent Document 3 does not point out improvement in electron emission efficiency of the cold cathode body having a cylindrical cup shape.

It is therefore one technical object of the present invention to provide a cathode body having a high intensity, a high efficiency, and a long life.

It is another technical object of the present invention to provide a method of manufacturing a cathode body having a high intensity, a high efficiency, and a long life.

It is still another technical object of the present invention to provide a manufacturing method suitable for a cathode body having a cylindrical cup shape.

### Means to Solve the Problem

In JP-A-2007-99778 and so on, the present inventors have previously proposed a magnetron sputtering apparatus which is capable of preventing local erosion of a target by moving a ring-shaped plasma region on the target with time and of increasing a film-forming rate by increasing a plasma density. The magnetron sputtering apparatus has a structure in which the target is disposed to face a substrate to be processed and a magnet member is arranged on a side opposite to the substrate with respect to the target.

Specifically, the magnet member of the magnetron sputtering apparatus mentioned above comprises a rotating magnet group comprising a plurality of plate magnets attached to a surface of a rotating shaft in a spiral arrangement, and a fixed outer circumferential frame magnet which is arranged at a periphery of the rotating magnet group in parallel with a target surface and which is magnetized in a direction perpendicular to the target. With this structure, by rotating the rotating magnet group, a magnetic field pattern formed on the target by the rotating magnet group and the fixed outer circumferential frame magnet is continuously moved in a direction of the rotating shaft. Consequently, a plasma region on the target can continuously be moved with time in the direction of the rotating shaft.

By using the magnetron sputtering apparatus mentioned above, it is possible to uniformly use the target over a long time and to improve the film-forming rate.

According to an experiment performed by the present inventors, it is found that the above-mentioned magnetron sputtering apparatus is applicable also to film formation of the cathode body having a cylindrical cup shape according to the present invention.

According to one aspect of the present invention, there is provided a cathode body characterized by comprising an electrode member having tungsten or molybdenum as a main constituent and containing at least one selected from a group consisting of La₂O₃, ThO₂, and Y₂O₃, and a film of a boride of a rare earth element formed on a surface of the electrode member by sputtering.

According to the present invention, there is also provided a cathode body characterized by having a carbon nanofiber layer formed on a conductor substrate, and a film of a boride of a rare earth element formed on a surface of the carbon nanofiber layer by sputtering

According to the present invention, there is also provided a cathode body characterized by comprising an electrode member having tungsten, molybdenum, or silicon as a main constituent provided with micro pyramids formed on a surface thereof and provided with a film of a boride of a rare earth element formed on a surface of the micro pyramids by sputtering.

Preferably, a LaB₆ film formed by sputtering is annealed in an inert gas atmosphere. In this event, a specific resistance of the LaB₆ film can be decreased.

### EFFECT OF THE INVENTION

According to the present invention, use is made of the electrode member formed of a mixture of tungsten having a high thermal conductivity and the material having a high electron emission efficiency. Furthermore, the boride film having a high electron emission efficiency is formed on the electrode member by sputtering. As a consequence, the boride film having an excellent adhesion can be attached to the electrode member. Thus, it is possible to obtain a cathode body having a high intensity, a high efficiency, and a long life.

Further, according to the present invention, it is possible to obtain a boride film which is formed by sputtering and which has a high electron emission efficiency.

### BRIEF DESCRIPTION OF THE DRAWING

FIG. 1 is a schematic view showing a magnetron sputtering apparatus for use in manufacturing a cathode body according to the present invention.

FIG. 2 is an enlarged sectional view of a part of FIG. 1.

FIG. 3 is a view showing a pressure dependency of a peak intensity of a (100) plane of a LaB₆ film and a sheet resistance when film formation is performed by sputtering by DC discharge.

FIG. 4 is a view showing a normalized ion dose dependency of the peak intensity of the (100) plane of the LaB₆ film and the sheet resistance.

### DESCRIPTION OF REFERENCE NUMERALS

1 target
2 columnar rotary shaft
3 rotating magnet group
4 fixed outer circumferential frame magnet
5 outer peripheral paramagnetic member
6 backing plate
7 housing
8 coolant passage
9 insulating material
11 process chamber space
12 feeder line
13 cover
14 outer wall
15 paramagnetic member
16 plasma shielding member
18 slit
19 cathode body manufacturing jig
30 cylindrical cup
301 cylindrical electrode portion
302 lead portion
321 receiving portion
322 flange portion
323 slope portion
341 thick LaB₆ film
342 thin LaB₆ film
343 bottom LaB₆ film

### BEST MODE FOR EMBODYING THE INVENTION

Hereinbelow, an embodiment of the present invention will be described with reference to the drawing.

### First Embodiment

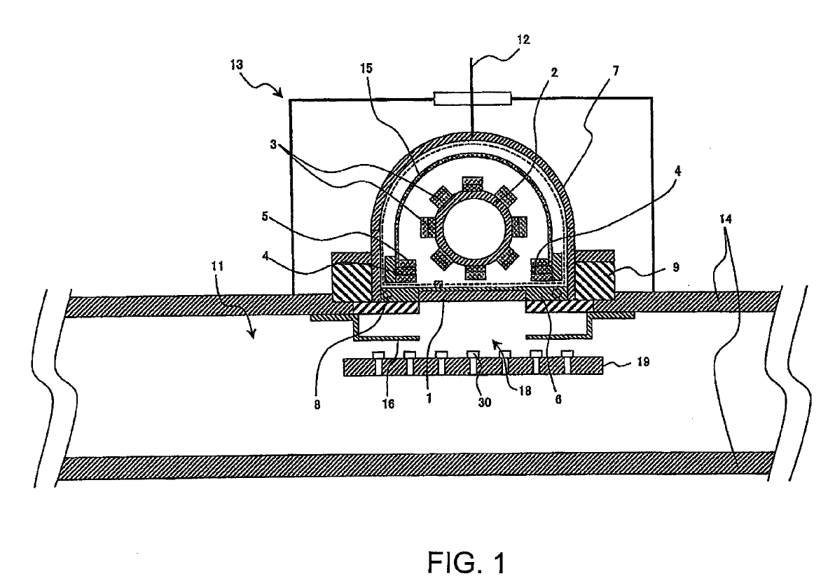

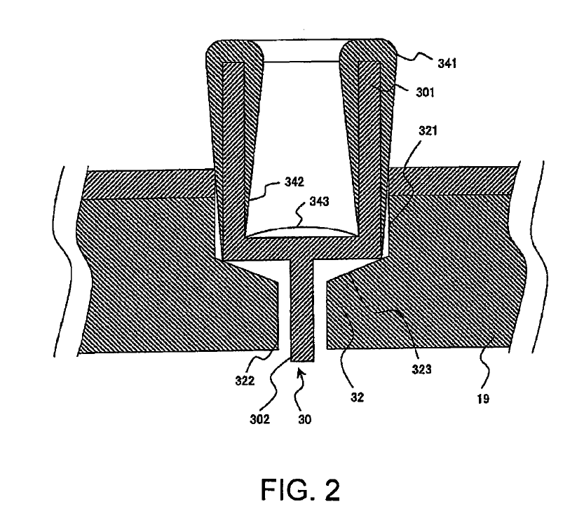

FIG. 1 is a view showing one example of a magnetron sputtering apparatus for use in the present invention. FIG. 2 is a view for describing a cathode body manufacturing jig for use in manufacturing a cathode body according to the present invention.

The magnetron sputtering apparatus shown in FIG. 1 comprises a target 1, a columnar rotary shaft 2 having a polygonal shape (for example, a hexadecagon shape), a rotating magnet group 3 comprising a plurality of spiral plate magnet groups attached to a surface of the columnar rotary shaft 2 in a spiral arrangement, a fixed outer circumferential frame magnet 4 arranged at an outer periphery of the rotating magnet group 3 so as to surround the rotating magnet group 3, and an outer peripheral paramagnetic member 5 formed on a side opposite to the target 1 with respect to the fixed outer circumferential frame magnet 4. Further, to the target 1, a backing plate 6 is attached. Each of the columnar rotary shaft 2 and the spiral plate magnet group 3 is covered with a paramagnetic member 15 except a part faced to the target 1. Further, the paramagnetic member 15 is covered with a housing 7.

As seen from the target 1, the fixed outer circumferential frame magnet 4 has a structure surrounding the rotating magnet group 3 comprising the spiral plate magnet group and is, herein, magnetized so that a S pole is formed on a side faced to the target 2. The fixed outer circumferential frame magnet 4 and each plate magnet of the spiral plate magnet group are formed of a Nd—Fe—B sintered magnet.

Further, in a process chamber space 11 inside a processing chamber shown in the figure, a plasma shielding member 16 is provided and a cathode body manufacturing jig 19 is disposed. The space is depressurized and plasma gas is introduced therein.

The plasma shielding member 16 shown in the figure extends in an axial direction of the columnar rotary shaft 2 and defines a slit 18 for opening the target 1 to the cathode body manufacturing jig 19. A region which is not shielded by the plasma shielding member 16 (namely, a region opened to the target 1 by the slit 18) is a region where a magnetic field intensity is high and a high-density low-electron-temperature plasma is generated so that a cathode body disposed on the cathode body manufacturing jig 19 is free from charge-up damage and ion irradiation damage and where a film-forming rate is high. A remaining region except the above-mentioned region is shielded by the plasma shielding member 16 so that film formation free from damage can be carried out without substantially decreasing the film-forming rate.

The backing plate 6 is provided with a coolant passage 8 for a refrigerant to pass therethrough. Between the housing 7 and an outer wall 14 defining the processing chamber, an insulating material 9 is disposed. A feeder line 12 connected to the housing 7 is extracted to the outside through a cover 13. The feeder line 12 is connected to a DC power source, a RF power source, and a matching unit (not shown in the figure).

With the above-mentioned structure, the DC power source and the RF power source supply a plasma excitation power to the backing plate 6 and the target 1 through the matching unit, the feeder line 12, and the housing to excite plasma on a surface of the target. It is possible to excite plasma only by a DC power or only by a RF power. However, in view of film quality controllability and film-forming rate controllability, both of these powers are desirably applied. The RF power has a frequency which is normally selected from a range between several hundreds kHz and several hundreds MHz. In order to achieve a high-density and low-electron-temperature plasma, a high frequency is desirable. In the present embodiment, a frequency of 13.56 MHz is used.

As shown in FIG. 1, the cathode body manufacturing jig 19 disposed in the process chamber space 11 inside the processing chamber holds a plurality of cylindrical cups 30 which are fixed thereto and each of which forms a cathode body.

Referring to FIG. 2 in addition, the cathode body manufacturing jig 19 has a plurality of supporting portions 32 supporting the cylindrical cups 30. Herein, as shown in FIG. 2, each of the cylindrical cups 30 comprises a cylindrical electrode portion 301 and a lead portion 302 extracted from a center of a bottom part of the cylindrical electrode portion 301 in a direction opposite to the cylindrical electrode portion 301. In this example, it is assumed that the cylindrical electrode portion 301 and the lead portion 302 are integrally molded by, for example, MIM (Metal Injection Molding) or the like.

Each of the supporting portions 32 of the cathode body manufacturing jig 19 comprises a receiving portion 321 defining an opening portion having a size adapted to receive the cylindrical electrode portion 301 of the cylindrical cup 30, a flange portion 322 defining a hole having a diameter smaller than that of the receiving portion 321, and a slope portion 323 connecting the receiving portion 321 and the flange portion 322. As shown in the figure, the cylindrical electrode portion 301 is inserted into and positioned in the supporting portion 32 of the cathode body manufacturing jig 19. Specifically, the lead portion 302 of the cylindrical electrode portion 301 passes through the flange portion 322 of the cathode body manufacturing jig 19 and an outer end of the cylindrical electrode portion 301 is brought into contact with the slope portion 323 of the cathode body manufacturing jig 19.

Herein, the cylindrical cup 30 shown in the figure is formed of tungsten (W) with 4% to 6% lanthanum oxide (La₂O₃) added thereto by volume ratio and comprises the cylindrical electrode portion 301 having an inner diameter of 1.4 mm, an outer diameter of 1.7 mm, and a length of 4.2 mm and the lead portion 302. The length may be shortened to, for example, approximately 1.0 mm. In this example, the cylindrical cup 30 is formed by mixing tungsten which is a fire-resistant metal having an excellent thermal conductivity with La₂O₃ having a work function as small as 2.8 to 4.2 eV. By using tungsten, heat generated in the cylindrical cup 30 can efficiently be discharged. By mixing lanthanum oxide having a small work function, electrons can be emitted from the cylindrical cup 30 itself also. Incidentally, as a high-thermal-conductivity metal for forming the cylindrical cup 30, molybdenum (Mo) may be used instead of tungsten.

Herein, a method of manufacturing the cylindrical cup 30 will be described in detail. First, a tungsten alloy powder containing 3% La₂O₃ by volume ratio was mixed with a resin powder. As the resin powder, styrene was used and a mixing ratio of the tungsten alloy powder and styrene was 0.5:1 by volume ratio. Next, a very small amount of Ni was added as a sintering agent to obtain pellets. Using the pellets thus obtained, metal injection molding (MIM) was performed in a mold having a cylindrical cup shape and at a temperature of 150° C. to form a molded product having a cup shape. The molded product thus formed was heated in a hydrogen atmosphere to be degreased. Thus, the cylindrical cup 30 was obtained.

The cylindrical cup 30 thus obtained was fixed to the cathode body manufacturing jig 19 illustrated in FIGS. 1 and 2 and brought into the processing chamber 11 of the magnetron sputtering apparatus in which a LaB₆ sintered body was set as the target 1.

Argon was introduced into the processing chamber 11 to reduce a pressure to approximately 20 mTorr (2.7 Pa). The cathode body manufacturing jig 19 was heated to a temperature of 300° C. and sputtering was performed.

Referring back to FIG. 2, a state of the cylindrical cup 30 after sputtering is schematically shown. As shown in the figure, a thick LaB₆ film 341 is formed in a region where an aspect ratio is 1, which is a ratio of a depth and an inner diameter of the cylindrical electrode portion 302. In a part located below an upper surface of the cathode body manufacturing jig 19, a thin LaB₆ film 342 is formed. Further, on an inner bottom surface of the cylindrical electrode portion 302, an extremely thin LaB₆ film (bottom LaB₆ film) 343 is formed.

In the example illustrated in the figure, the thick LaB₆ film 341, the thin LaB₆ film 342, and the bottom LaB₆ film 343 have thicknesses of 300 nm, 60 nm, and 10 nm, respectively.

By an experiment conducted by the present inventors, it was confirmed that the cathode body having the above-mentioned LaB₆ films could maintain a high efficiency and a high intensity over a long time.

For example, on a surface of a molybdenum electrode free from an additive, a LaB₆ film was formed by sputtering using Ar plasma on the condition of DC power of 900 W, a temperature of 300° C. of a substrate 301 (namely, the jig 19), and a vacuum degree of 20 mTorr (2.7 Pa). Then, annealing was performed at a temperature of 800° C. Those electrodes thus obtained were used as a pair of cold cathodes and enclosed in a glass tube having a length of 300 mm and a diameter of 3 mm to form a cold cathode fluorescent tube. Then, a lamp current of 6 mA was applied to the cold cathode fluorescent tube and a lamp voltage was measured. As a result, the cold cathode fluorescent tube required the lamp voltage of 550 to 553 Vrms. As compared to a case where a cold cathode fluorescent lamp using an electrode with no LaB₆ film required a lamp voltage of 566 Vrms, the lamp voltage was reduced by 13V to 16V. Thus, it was confirmed that an electric power necessary for light emission could be reduced and, therefore, a high-efficiency lamp was obtained.

As a condition for forming the LaB₆ film by sputtering, it is preferable that a surface of an electrode material is first cleaned by plasma before film formation. For example, it is suitable to use Ar plasma at 90 mTorr (12 Pa) and RF power of 300 W. When a chamber during sputtering is kept at a pressure of around 20 mTorr (2.7 Pa) (with Ar plasma, an electron temperature of approximately 1.9 eV, an ion irradiation energy of approximately 10 eV), a specific resistance is minimized (approximately 200 μΩcm before annealing). At this time, a film-forming rate is 90 nm/minute. If a pressure is reduced to 10 mTorr (1.3 Pa), the film-forming rate is increased to 100 nm/minute or more and the specific resistance is increased only slightly. Accordingly, the pressure is preferably 5 to 35 mTorr (0.67 Pa to 4.7 Pa). If a substrate temperature (stage temperature) is increased, the specific resistance is further reduced. With Ar at 20 mTorr (2.7 Pa) and at a substrate temperature of 300° C., the specific resistance is approximately 175 μΩcm. Furthermore, by annealing after film formation, the specific resistance is further reduced. If annealing is performed at a temperature of 800° C. in high-purity Ar, the specific resistance is approximately 100 μΩcm. An annealing temperature is preferably 400° C. to 1000° C. An annealing time must be not less than 30 minutes. For example, the annealing time not more than 3 hours is sufficient. Preferably, annealing is carried out in an inert gas atmosphere.

Next, for the purpose of examining an optimum condition for film formation of the LaB₆ film by sputtering, an experiment was carried out as follows. A SiO₂ film having a thickness of 90 nm was formed on a Si substrate by thermal oxidation and a LaB₆ film having a thickness of 80 nm was deposited thereon using the rotating magnet sputtering apparatus in FIG. 1. During the experiment, the following parameters were changed and an orientation (XRD measurement) and a resistivity were measured.
Film formation pressure (5 mTorr to 90 mTorr, 0.67 Pa to 12 Pa by SI unit)
Ion irradiation energy (9 eV to 80 eV)
Normalized ion dose (Ar+/LaB₆=approximately 1 to 20)

According to a result of the XRD measurement, it was found that the LaB₆ film formed by sputtering using the rotating magnet sputtering apparatus exhibited extremely low intensities for (210), (200), and (110) crystal planes and an extremely high intensity for a (100) crystal plane and had an excellent film quality. As compared to a conventional film formation by sputtering in which a (100) intensity was low, the above-mentioned feature is said to be one of the characteristics of the present invention.

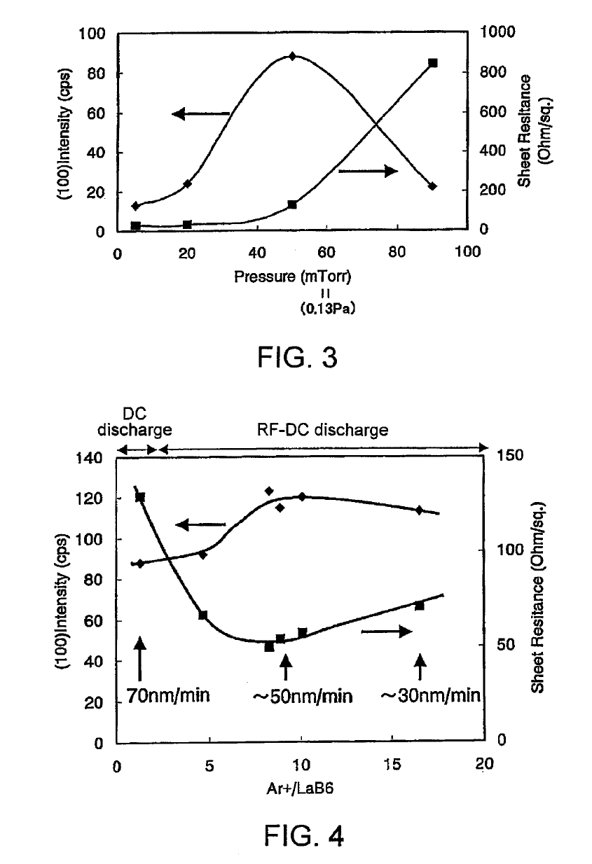

FIG. 3 shows a pressure dependency of a (100) peak intensity and a sheet resistance of the LaB₆ film according to the present invention. This is a data in a case where plasma is formed by applying a DC power of 900 W using an Ar gas. As shown in FIG. 3, it is understood that, by DC discharge in Ar at approximately 20 mTorr (2.7 Pa) or less, a sheet resistance is extremely low (approximately 200 μΩcm as a specific resistance value) but a (100) peak intensity is low and, therefore, crystallinity is low. On the other hand, by DC discharge in Ar at around 50 mTorr (6.7 Pa), it is possible to obtain a LaB₆ film of substantially (100) orientation but a resistance is increased (approximately 1000 μΩcm as a specific resistance value).

On the other hand, FIG. 4 shows variations in the (100) peak intensity and in the sheet resistance when a normalized ion dose is changed from approximately 1 to approximately 20. Referring to the figure, it is found that, in case where the ion irradiation energy is suppressed to approximately 10 eV or less and the normalized ion dose is increased to approximately 5 to 17 by RF-DC coupled discharge, the resistance is reduced (300 to 400 μΩcm as a specific resistance value) and the crystallinity is improved. The results in FIG. 4 are obtained when a pressure of Ar is 50 mTorr (6.7 Pa), all of ion irradiation energies are about 9.0 eV, and all of target power densities are about 2 W/cm². In FIG. 4, the DC discharge is performed at 900 W and the normalized ion dose (Ar+/LaB₆) during the DC discharge is 1.3. In the RF-DC discharge, a RF frequency is 13.56 MHz and a RF power is 600 W. When the normalized ion dose (Ar+/LaB₆) is 8.3, 10.1, and 16.5, DC voltage is −270V, −240V, and −180V, respectively.

In the above-mentioned embodiment, the cathode body for a cold cathode tube has been described. However, the present invention is also applicable to a fluorescence emitting apparatus of a surface-emitting type. Specifically, the present invention is effective when it is applied to the fluorescence emitting apparatus of a surface-emitting type which comprises a cathode substrate and an anode substrate faced to each other, a cathode electrode and an emitter formed on the cathode substrate, an anode electrode formed on the anode substrate, and a carbon nanotube, a carbon nanofiber, a graphite fiber, or the like used for the emitter. Specifically, by providing the emitter mentioned above with the LaB₆ film according to the present invention, which is formed by sputtering using the rotating magnet sputtering apparatus, it is possible to construct a light-emitting apparatus having a high efficiency, a high intensity, and a long life.

Further, the present invention is also applicable to a cathode body for a hot cathode tube.

Specifically, a member having tungsten or tungsten with 2 to 4% La₂O₃ and Th₂O₃ added thereto and a LaB₆ thin film formed on a surface thereof is used as the cathode body for a hot cathode fluorescent lamp.

By adhering a patterned nonreflecting plastic film to a surface of a tube of a fluorescent lamp using the above-mentioned cathode body, it is possible to improve an efficiency by 30 to 40% as compared to a conventional product.

Further, when the present invention is applied to the cathode body for the hot cathode tube, the cathode body may also be used for a bulb-type fluorescent lamp (fluorescent lamp usable with a socket for an incandescent lamp and adapted to be directly fitted thereto).

In this case, a distance between electrodes is shortened and voltage drop due to recombination of electrons and ions on a tube wall is suppressed. Therefore, a luminance efficiency becomes 2 to 2.5 times that of a conventional product.

As compared to a tube-type fluorescent lamp, the bulb-type fluorescent lamp has a smaller distance between electrodes. Presumably, an effect of the tube wall is small and an effect of an electrode material is more significantly reflected.

In the foregoing, the present invention has been described in connection with the W or the Mo electrode member containing at least one material selected from a group consisting of La₂O₃, ThO₂, and Y₂O₃. However, an excellent effect is obtained also if the LaB₆ film is formed by sputtering according to the present invention on a surface of a commonly-used cathode body having tungsten or molybdenum as a main constituent, or on a surface of a substrate formed of a different material.

Further, it is possible to obtain a more excellent cathode body by comprising a carbon nanofiber layer formed on a conductor substrate and a film of a boride of a rare earth element formed on a surface of the carbon nanofiber layer by sputtering according to the present invention. This is because the carbon nanofiber layer has a high electron emission effect since a number of very small sharp projections are formed on the surface thereof. Similarly, an excellent effect is obtained by forming a number of micro pyramids on a surface of an electrode member having tungsten, molybdenum, silicon, or the like as a main constituent and forming a film of a boride of a rare earth element by sputtering on a surface of the micro pyramids.

### INDUSTRIAL APPLICABILITY

The present invention is applicable not only to a cold cathode body provided with a cylindrical cup but also to a hot cathode body provided with a filament and a surface-emitting-type fluorescence emitting apparatus having an emitter in a similar manner.

1. A cathode body by comprising an electrode member having tungsten or molybdenum as a main constituent and containing at least one selected from a group consisting of La₂O₃, ThO₂, and Y₂O₃, and a film of a boride of a rare earth element formed on a surface of the electrode member, wherein said boride film is formed by sputtering.

2. The cathode body as claimed in claim 1, wherein said boride of a rare earth element contains at least one boride selected from a group consisting of LaB₄, LaB₆, YbB₆, GaB₆, and CeB₆.

3. The cathode body as claimed in claim 2, wherein said one boride of a rare earth element is LaB₆.

4. The cathode body as claimed in claim 1, wherein said electrode member comprises a cylindrical electrode portion and a lead portion extracted from the cylindrical electrode portion, said cylindrical electrode portion and said lead portion being integrally molded.

5. The cathode body as claimed in claim 1, wherein said electrode member contains 4 to 6% La₂O₃ by volume ratio.

6. A fluorescent tube using, as a cold cathode, the cathode body claimed in claim 1.

7. A fluorescent tube using, as a hot cathode, the cathode body claimed in claim 1.

8. A method of manufacturing a cathode body comprising by a step of;
forming a LaB₆ film by sputtering using a magnetron plasma sputtering apparatus on at least a portion of a surface of the cathode body having tungsten or molybdenum as a main constituent, on at least a portion of a surface of a cathode body having a carbon nanofiber layer formed on a conductor substrate, or on at least a part of a surface of a cathode body having micro pyramids formed on an electrode member.

9. The method of manufacturing a cathode body as claimed in claim 8, further comprising steps of preparing, a plurality of cylindrical cups each comprising a cylindrical electrode portion and a lead portion integrally formed therewith, fixing said the cylindrical cups to a cathode body manufacturing jig having a supporting portion supporting a plurality of said the cylindrical cups, and bringing the cathode body manufacturing jig with said cylindrical cups fixed thereto into said magnetron plasma sputtering apparatus provided with a target comprised of LaB₆.

10. The method of manufacturing a cathode body as claimed in claim 9, wherein said cathode body manufacturing jig has a supporting portion supporting said cathode bodys, said supporting portion comprising a receiving portion having an opening portion adapted to receive the cylindrical electrode portion of each of said cylindrical cups, a flange portion allowing the lead portion of each of said cylindrical cups to pass therethrough, and a slope portion connecting said receiving portion and said flange portion.

11. A fluorescence light-emitting device of a surface light-emitting type, comprising an emitter having a LaB₆ film formed by sputtering.

12. A cathode body having tungsten or molybdenum as a main constituent, having a LaB₆ film formed on a surface thereof by sputtering.

13. A cathode body having a carbon nanofiber layer formed on a conductor substrate, and a film of a boride of a rare earth element formed on a surface of the carbon nanofiber layer by sputtering.

14. A cathode body comprising an electrode member with micro pyramids are formed on a surface thereof and a film of a boride of a rare earth element is formed by sputtering on a surface of said micro pyramids.

15. The cathode body as claimed in claim 14, wherein said electrode member comprises tungsten, molybdenum, or silicon as a main constituent.

16. A method of manufacturing a cathode body, comprising a step of forming a LaB₆ film on a substrate by sputtering, and a step of annealing the LaB₆ film in an inert gas atmosphere.

17. The method of manufacturing a cathode body as claimed in claim 16, wherein an annealing temperature is 400° C. to 1000° C. in said annealing step.

18. A method of manufacturing a cathode body, comprising a step of forming a LaB₆ film on a substrate by sputtering wherein the LaB₆ film is formed by sputtering by RF-DC coupled discharge with a normalized ion dose of 5 to 17.

19. A method of manufacturing a LaB₆ film, comprising a step of forming the LaB₆ film on a substrate by sputtering, wherein the LaB₆ film is formed by sputtering by RF-DC coupled discharge with a normalized ion does of 5 to 17.

20. The method of manufacturing a LaB₆ film as claimed in claim 19, further comprising, after the step of forming the LaB₆ film on the substrate by sputtering, a step of annealing the LaB₆ film in an inert gas atmosphere.
